(19) United States
(12) Patent Application Publication
(10) Pub. No.: US 2004/0153574 A1
(43) Pub. Date: Aug. 5, 2004

(54) Method and apparatus for specifying communication indication matching and/or responses

(75) Inventors: Fred Cohen, Livermore, CA (US); Anthony George Carathimas, Oakland, CA (US); Eric Daniel Thomas, Livermore, CA (US)

Correspondence Address: QUINE INTELLECTUAL PROPERTY LAW GROUP, P.C., P O BOX 458, ALAMEDA, CA, 94501, US

(73) Assignee: Sandia National Laboratories

(21) Appl. No.: 10/438,253

(22) Filed: May 13, 2003

Related U.S. Application Data
(60) Provisional application No. 60/380,824, filed on May 13, 2002.
(60) Provisional application No. 60/416,285, filed on Oct. 3, 2002.

(51) Int. Cl. G06F 15/16

(52) U.S. Cl. 709/245

(57) ABSTRACT

A method and/or system providing and/or indicating configurable and selectable strategies for responding to data units.

### CROSS REFERENCE TO RELATED APPLICATIONS

This application claims priority from provisional patent application 60/380,824 filed 13 May 2002 entitled METHOD AND APPARATUS FOR AN INVISIBLE ROUTER/DAZZLER and from provisional patent application 60/416,285 filed 3 Oct. 2002 entitled METHOD AND APPARATUS PROVIDING DECEPTIONS AND/OR ALTERED OPERATIONS IN INFORMATION SYSTEMS.

This application is related to patent application Ser. No. 09/696,893 filed 26 Oct. 2000 entitled METHOD AND APPARATUS FOR NETWORK DECEPTION/EMULATION, which claims priority from provisional patent application 60/165,581 filed Nov. 15, 1999.

### GOVERNMENT RIGHTS

This invention was made with Government support sponsored by the United States Department of Defense under MIPR1CDOEJG102 2112040 162-3825 P633D06 255X 633006.247.01.DD.00 JGBZZ.1 JOAN 1JG8CA. The Government has certain rights to this invention.

### COPYRIGHT NOTICE

Pursuant to 37 C.F.R. 1.71(e), applicants note that a portion of this disclosure contains material that is subject to copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records, but otherwise reserves all copyright rights whatsoever.

### FIELD OF THE INVENTION

The present invention is related to the field of data and/or communication networks.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

In the history of conflict, providing deceptive information to adversaries has been a cornerstone of successful offense and defense. Information protection has included such examples of deception for defense as honey pots to gain insight on attacker behavior, lightning rods to draw fire, and program evolution as a technique for defending against automated attacks on operating systems. Long before computers existed, information protection through deception was widely demonstrated, however this history also demonstrates that deception is used far more by attackers than defenders.

Address Translation

Some techniques that have been found useful for defensive deception involve address translation. Address translation is, in general, a known technique in the art and many systems and methods that can provide various types of address translation are known. FIG. 1 is a block diagram illustrating address translations between a first client network and a second server network using a proxy server as known in the prior art. One common use of translations is to separate an inside network containing internal IP addresses from an outside network, such as the Internet. Consider a LAN with 100 computers, each having an IP address of the form 10.*.*.*. The computers can talk with any other computer on the LAN, using the 10.*.*.* IP addresses as source and destination addresses in transmitted packets. However, when an inside computer wishes to communicate to an address on the outside internet, an issue arises in that the internal IP address may not be a valid external IP address. For example, destination addresses beginning with 10. are reserved for private networking and are not routable on the Internet. Also, internal IP addresses may have been assigned without acquiring the corresponding external IP address. So an internal address of 24.24.24.2, for example, may be registered in the external network to another institution. Therefore, while an inside computer 10.n.m.o might be able to transmit a packet out over the Internet with a valid external destination address, no packets can be returned from the external network if the original source address is 10.n.m.o or another not valid IP address because that address cannot be correctly routed over the external Internet.

A second issue is that valid external IP addresses can be expensive, and an institution with a very large number of computers may not wish to buy a valid external IP address for each computer if it is not necessary. In the simplest case, an institution might wish to use just one external IP address for its entire LAN.

To solve these problems, network administrators use a network computing device or logic module sometimes referred to as a Proxy Server (or just proxy) or an Address Translation Gateway (ATG). An ATG sits between a private LAN network or server network and the outside network. It receives any packet on the LAN that is addressed to an outside computer, and translates at least the source address of that packet before placing that packet on the Internet. A return packet is routed back to the ATG using the translated source address as the destination and the ATG or proxy again translates the packet addresses and places the packet on the internal network.

Translations can be accomplished by a variety of techniques known in the art, such as table-lookup, rules-based translations algorithms, using port fields to hold portions of an address, or using transmit and response timing to match packets. An ATG keeps track of internal address/external address pairs so that when it receives packets from the external network, they can be sent over the LAN to the correct individual machine. The ATG/proxy function can be performed by logic within another network device (such as a firewall and/or server and/or bridge) or the function can be performed by a dedicated gateway computer. Additional information about gateways, internet addressing, and subnetworks can be found from a variety of sources, such as www.sohointer.net/learn/gateways.htm and www.sohointer.net/learn/addrs.htm and the pages referenced therein.

An ATG functionality will typically be incorporated with other functions in a network device. Thus, devices acting as firewalls, routers, or servers can include ATG functions. Network capable devices with ATG functionality are available from a number of different vendors. Examples of such devices include Cisco Routers, the Linux OS, FreeBSD.

Standard components, configurations, and capabilities provided by such devices include:

1. At least two interfaces for connecting between two separate communication environments (such as a local network and an outside network).

2. At least one external interface able to detect and receive packets on an external network directed to the ATGs external network addresses.

3. At least one internal interface able to detect and receive packets on said internal network directed to one or more external network addresses.

4. An address translation ability to change source and destination addresses for packets transferred between the internal interface and the external interface.

5. An address facility able to map between external addresses and internal addresses.

Some routers, particular earlier routers, were essentially general purpose computers with at least two communication interfaces that performed all routing functions using programmable logic instructions (e.g., computer programs written in generally higher level programming languages, such as C). Thus, there are many examples of providing communication data handling and/or routing functions using stored program programmable computers.

Inventor Fred Cohen has written a number of papers and books regarding network and data security deception. Many of these writings are available at all.net. Some of these publications are listed in the section below. All of these references are incorporated herein by reference. The brief summaries provided below are not comprehensive and not intended to suggest that other materials are not present in the referenced publications.

### OTHER REFERENCES

1. [Bellovin92] S. M. Bellovin. There Be Dragons. Proceedings of the Third Usenix UNIX Security Symposium. Baltimore (September 1992). [In this paper, numerous foiled attacks from the Internet against AT&T are described and the author details how some of these are traced and what is done about them.

2. [Cohen96] F. Cohen, Internet Holes—Internet Lightning Rods Network Security Magazine, July, 1996. [This paper describes the use of a system as an intentional target over a period of several years to draw fire from more critical systems and to learn about attack and defense behavior.] http://all.net/journal/netsec/9607-2.html

3. [Cheswick91] Bill Cheswick, Steve Bellovin, Diana D'Angelo, and Paul Glick, An Evening with Berferd [In this paper, the details of an attack rerouted to a Honey Pot are demonstrated. The defenders observed and analyzed attacks with a jury-rigged fake system that they called the ‘Jail’.]

4. [Cohen97] F. Cohen, Information System Attacks—A Preliminary Classification Scheme Computers and Security, 1997. [This paper describes almost 100 different classes of attack methods gathered from many different sources.] http://all.net/CID/Attack/Attack.xref

5. [Cohen97-2] F. Cohen, Information System Defenses—A Preliminary Classification Scheme Computers and Security, 1997. [This paper describes almost 140 different classes of protective methods gathered from many different sources.] http://all.net/CID/Defense/Defense.xref

6. [Cohen96-03] F. Cohen Internet Holes—The Human Element, Network Security Magazine, March, 1996 http://all.net/iournal/netsec/9603.html

7. [Cohen98] F. Cohen et. al. Model-Based Situation Anticipation and Constraint

8. [Cohen96-04] F. Cohen, Internet Holes—Incident at All.Net [This paper described an Internet-based distributed coordinated attack against the all.net Internet site and gives examples of deception used by attackers to create the impression that deception for defense is unfair and inappropriate] http://all.net/ioumal/netsec/9604.html

9. [Cohen96-DCA] F. Cohen, A Note On Distributed Coordinated Attacks, [This paper describes a new class of highly distributed coordinated attacks and methods used for tracking down their sources.] http://all.net/books/dca/top.html

10. [Cohen85] F. Cohen, Algorithmic Authentication of Identification, Information Age, V7#1 (January 1985), pp 35-41.

11. [Cohen98-04] F. Cohen Managing Network Security—The Unpredictability Defense] http://all.net/journal/netsec/9804.html

12. [Howard97] J. Howard, An Analysis Of Security Incidents On The Internet Dissertation at Carnegie-Mellon University [This research analyzed trends in Internet security through an investigation of 4,299 security-related incidents on the Internet reported to the CERT. Coordination Center (CERT./CC) from 1989 to 1995.]

13. [Cheswick94], W. Cheswick and S. Bellovin, Firewalls and Internet Security—Repelling the Wiley Hacker Addison-Wesley, 1994. [This book is one of the most authoritative early sources of information on network firewalls. It includes many details of attack and defense techniques as well as case studies of attacks against AT&T.]

14. [Cohen97-3] National Info-Sec Technical Baseline—Intrusion Detection and Response [This paper covers the state of the art in intrusion detection and includes an extensive review of the literature while identifying key limitations of current intrusion detection technology.] http://all.net/journal/ntb/ids.html

15. [Cohen-98] National InfoSec Technical Baseline—At the Intersection of Security, Networking, and Management [This paper covers the state of the art in network security management and secure network management and includes an extensive review of the current state of the art and identifies key limitations of current technology.] http://all.net/journal/ntb/nsm.html

The present invention in various specific aspects and embodiments is directed to methods and/or systems and/or devices useful in data communication settings, particularly in addressed communication networks that are characterized by having data units that are associated with source and/or destination address. Such networks can be wireless networks, cable networks, and/or networks carried over telephone lines and/or mixtures of such networks. One type of such a network is the world-wide Internet and its connected networks that communicate using an IP protocol at one layer. Other types of networks can include cellular phone networks, cable television networks, ATM networks, optical networks, etc.

In specific aspects and embodiments the invention involves methods and or devices that can be used to provide a variety of deception and/or protection techniques for preventing unauthorized users from accessing a protected network and/or for confusing unauthorized users or attackers with false information.

In some embodiments, the invention may be involved with or embodied in a logical module or device or system referred to herein as an Invisible Router (IR). An IR according to specific embodiments of the invention is a configurable network module that can be used to help protect parts of a network and/or network entities from attacks from the outside. Furthermore, in specific embodiments, an IR according to the invention is “invisible” in that it operates on the network but generally does not have an accessible IP address and/or MAC address and thus is generally not perceivable to any other entities on the network.

In a further embodiment, a logic module and/or device according to specific embodiments of the invention can act both as an enhanced firewall system that allows only permitted or selected traffic and can be easily configured to handle various traffic streams and can also act as a dazzler or deception device that provides a wide range of configurable deceptive responses to unauthorized users.

According to specific embodiments of the present invention, a network system according to the invention can perform MAC address translations in addition to other modifications in order to provide enhanced deceptions and/or enhanced firewall features. MAC address translations are not a typical part of previous firewall type systems.

In various embodiments, the present invention provides a number of novel deception strategies. In general terms, these deception methods include using a network (e.g., IP) address (either a real and/or a deceptive IP address) or other seed and a pseudo-random number generator (PRNG) to generate other deceptive network addresses (e.g., MAC addresses). A further example deceptive method according to specific embodiments of the present invention is dazzlement, as described further below.

In further embodiments, the invention involves with a router that extends at a basic level responses to packets. In general, previous routers have one of three basic responses or actions to a received data packet: (1) Forward (optionally modifying very restricted parts of a packet, such as the TOS field; (2) Ignore (e.g., do not forward the packet and make no response to the sender and (3) Deny (send a specific type of response to the sender, such as a reset, to indicate that the packet was not accepted by the destination address.) According to specific embodiments of the present invention, one or more further basic operating responses are provided, such as: (4) Dazzle; (5) Mirror; and (6) Concealment. Various novel network data handling methods are described below and can be incorporated and/or used with specific embodiments of the invention.

In further embodiments, an IR system or module of the present invention includes a continuation function and/or option that, unlike traditional routers, allows a packet analyzer as generally understood in the art to continue comparing packets to matching criteria even after an initial match is fired and/or an initial action is taken. In a further embodiment, the present invention provides an IR that can generate one or more data packets in response to receiving a single data packet.

In a further embodiment, the invention provides an IR system and/or module that can respond to received packets, especially unauthorized packets, without processing those packets through an entire actual network (e.g., IP) protocol stack. This allows, for example, a single IR according to specific embodiments of the present invention, with a processor clock speed of about 500 MHz to consume up to about four 100 MHz transmission interfaces.

In a further embodiment, the invention involves a method and/or system that can perform a Broadcast Response wherein a number of non-existent addresses all machines respond as though, for example, they were PINGed. With such a response, a method of the invention can indicate to an incoming PING that up to about 200 systems have responded to a PING, thus overwhelming an attacker with false response.

In a further embodiment, the invention provides an IR that can provide probabilistic deception responses or partial responses. In one example, an IR may respond to only 80% of incoming packets from a particular address or that match a particular criteria, thus causing an attacker to believe that there is some noise on the line or that the connection is slow. In a further example, an IR may respond to syn packets from a particular attacker, but ignore ack packets, thus causing the sending protocol to enter a wait loop, which can significantly slow down automated attack mechanisms.

In further embodiments, the invention provides a novel method and/or device allowing access to an IR according to specific embodiments of the present invention without assigning an IP or MAC address to the IR. The technique is referred to herein as a loop-back interface and operates to allow specific external packets to be transferred into processes residing within the IR even though there is no address assigned to the IR.

In further embodiments, the invention is involved with novel methods for expressing network address ranges (particularly IP addresses) for stimulus rules and expressing actions taken in response to stimulus.

According to specific embodiments of the invention, the invention involves one or more novel network topologies to provide enhanced network functionality. While firewalls that divide an inside network from an outside network are known, the present invention is further involved with a novel network device and/or method that can separate networks into three or more separate spaces, such as an inside protected network, an outside network, and one or more deception networks.

A further understanding of the invention can be had from the detailed discussion of specific embodiments below. For purposes of clarity, this discussion refers to devices, methods, and concepts in terms of specific examples. However, the method of the present invention may operate with a wide variety of types of communication systems and logic systems. It is therefore intended that the invention not be limited except as provided in the attached claims. Furthermore, it is well known in the art that logic systems can include a wide variety of different components and different functions in a modular fashion. Different embodiments of a system can include different mixtures of elements and functions and may group various functions as parts of various elements. For purposes of clarity, the invention is described in terms of systems that include many different innovative components and innovative combinations of components. No inference should be taken to limit the invention to combinations containing all of the innovative components listed in any illustrative embodiment in this specification.

The invention as described herein at times refers to transmission of various packets, datagrams, PDU's or data units of data. These terms should be understood as generally equivalent and indicate any known format for exchanging data.

Furthermore, for purposes of clarity, aspects of the invention are at times described with reference to particular example IR systems, including particular configuration notations. As discussed herein, specific examples are for illustration of specific embodiments and the invention has other detailed applications and embodiments.

Various embodiments of the present invention provide methods and/or systems for protecting information systems that can be implemented on a general purpose or special purpose information handling appliance using a suitable programming language such as Java, C++, Cobol, C, Pascal, Fortran., PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and equivalents.

All publications, patents, and patent applications cited herein are hereby incorporated by reference in their entirety for all purposes. The invention will be better understood with reference to the following drawings and detailed description.

### BRIEF DESCRIPTION OF THE DRAWINGS

FIG. 1 is a block diagram illustrating address translations between a first client network and a second server network using a proxy server as known in the prior art.

FIG. 2 is a block diagram illustrating a deployment of an early version of a deception tool kit in individual computer systems, with each deployment providing deception services at a single computer system.

FIG. 3 is a block diagram showing a deployment of an advanced Deception Tool Kit within a network providing deceptive services at multiple addresses.

FIG. 4 is a block diagram illustrating an example of multiple address translations.

FIG. 5 is a flowchart illustrating a general method for protecting one or more information systems according to embodiments of the present invention.

FIG. 6 is a flowchart illustrating a general method for providing counter actions against attacking information systems according to embodiments of the present invention.

FIG. 7 illustrates an example communication configuration showing a network device according to specific embodiments of the invention configured as one device in a local network having at least one communication interface.

FIG. 8 illustrates an example communication configuration showing a network device according to specific embodiments of the invention as a logic module incorporated in a firewall between an internal network and an external network.

FIG. 9 illustrates an example communication configuration showing a network device according to specific embodiments of the invention configured as a device separating an internal network from an external network and having at least two communication interfaces.

FIG. 10 illustrates an example communication configuration showing a network device according to specific embodiments of the invention configured as a device outside a firewall separating an internal network from an external network.

FIG. 11 illustrates an example communication configuration showing a network device according to specific embodiments of the invention configured as a device inside a firewall separating an internal network from an external network.

FIG. 12 illustrates an example communication configuration showing a network device according to specific embodiments of the invention configured as a device separating an internal network from an external network and providing for one or more additional networks and having at least three communication interfaces.

FIG. 13 illustrates an example configuration of an application of the present invention for protecting one or more information systems.

FIG. 14 illustrates an example logic or information handling device in which aspects of the present invention may be embodied.

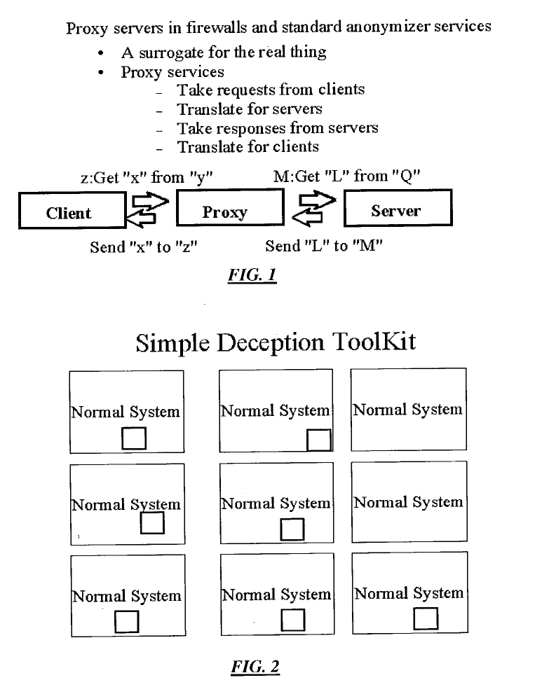

### DESCRIPTION OF SPECIFIC EMBODIMENTS

1. Overview

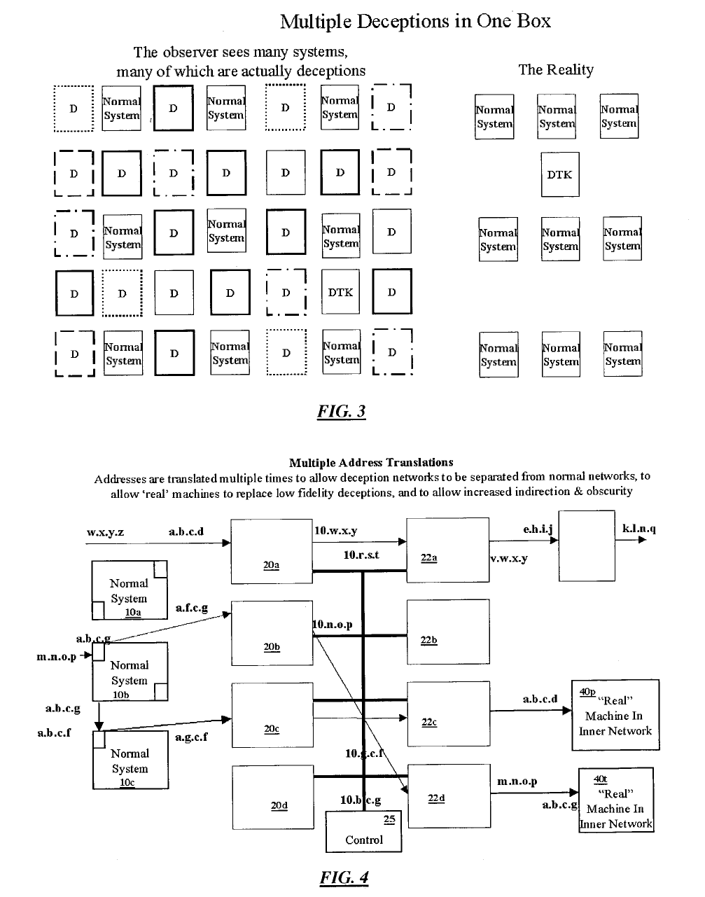

Some earlier discussed techniques for network data handling involve multiple address translations in order to provide some types of protection and deception in network systems or involved deception modules that ran on one or more information processing systems in a network. For example, FIG. 2 is a block diagram illustrating a deployment of an early version of a deception tool kit in individual computer systems, with each deployment providing deception services at a single computer system. FIG. 3 is a block diagram showing a deployment of an advanced Deception Tool Kit within a network providing deceptive services at multiple addresses. FIG. 4 is a block diagram illustrating an example of multiple address translations.

2. Invisible Router (IR)

According to specific embodiments, the present invention may be embodied as a logic module and/or device and/or system referred to at times herein as the Invisible Router (IR) and also referred to at times herein as the Dazzler. The term Invisible Router reflects the characteristics that a device and/or system according to specific embodiments of the present invention is “invisible” in that users on a network do not need to know it exists and it does not need to inform them. Router refers to the characteristic that such a device in specific embodiments and/or configurations routes network information where it is supposed to go, in some ways similarly to a traditional router. The term Dazzler indicates a number of other functions that can be performed according to specific embodiments of the present invention as further described herein.

According to specific embodiments of the present invention, an IR is a communication data handling device that can respond in a number of configurable ways to an incoming packet to decide what to do with that incoming packet. An IR can be implemented using any configurable or programmable router or other logic execution device that is capable of examining data units, executing logic instructions, and issuing one or more data units. An IR according to specific embodiments of the invention, can be understood as a stored-program computer with one or more communication interfaces and one or more processes for executing logic instructions.

In further embodiments, an IR can be understood as one or more logic modules or functions that are incorporated into a traditional router or other network system and/or device. According to specific embodiments of the invention, an IR can be embodied as one or more sets of logic instructions for execution by any suitable logic execution circuitry such as a special purpose or general purpose central processing unit (CPU).

In further embodiments, an IR can be understood as an application specific information processing device and or system and can have one or more custom logic components for performing one or more functions as described herein. According to further specific embodiments of the invention, an IR can be embodied as one or more sets of logic instructions for execution by any suitable logic execution circuitry such as a special purpose or general purpose central processing unit (CPU).

In specific embodiments, an ordered set of stimulus-response rules is used in conjunction with an IR logic execution instructions and/or device to specify how an IR will respond to a particular packet. For example, in specific implementations, these rules can reside in a ‘rules’ file that an IR reads when it starts up or is told to do an update and then uses to determine responses to stimuli, e.g., received packets. In essence, for each rule, if the rule matches the stimulus provided, an IR will take the specified action in response. In such an embodiment, an IR will include logic instructions such as a rules execution module to execute rules according to the methods described herein.

Responses to Received Packets

Thus, in particular embodiments, the present invention can be understood as a logic module and/or method and/or device that receives packets or data units and that takes one or more configurable actions in response thereto. Operation according to specific embodiments of the invention can be understood by comparison with a traditional router function. In general, a traditional router has one of three basic responses or actions to a received data packet: (1) Forward (optionally modifying very restricted parts of a packet, such as the TOS field; (2) Ignore (e.g., do not forward the packet and make no response to the sender), and (3) Deny (send a specific type of response to the sender, such as a reset, to indicate that the packet was not accepted by the destination address.) Generally, these responses are made in a device with at least two interfaces and in some cases are used in firewall-type devices that separate one network space from another network space and optionally perform some type of address translation.

In specific embodiments, the present invention extends at a basic level responses to packets. In addition to providing one or more of the responses described above to packets, a logic module or device or system according to specific embodiments of the present invention can provide one or more further basic operating responses, which can most generally be described as (4) provide a deceptive response or (5) provide a concealment action, transferring the packet into another address space. Some of these responses can be provided from a device on a network with a single communication interface.

In further specific embodiments, the invention provides responses to IP packets without processing packets through an entire actual IP protocol stack. This allows, for example, a logic module or device according to specific embodiments of the present invention to produce a large amount of network traffic without using up a corresponding amount of CPU resources.

Standard Responses

FIG. 5 is a flowchart illustrating a general method for protecting one or more information systems according to embodiments of the present invention. In various specific embodiments, a logic device and/or module according to specific embodiments of the invention can provide one or more standard router-type responses to incoming packets such as ignore, deny, or forward. In specific embodiments, these standard responses can be modified using one or more options as discussed below, including probabilistic options. In further embodiments, one or more of these responses can be used in a deceptive manner. A deny response, for example, typically indicates that the IP address associated with a request exists. This can allow port scanner type attackers to find legitimate ports at that address. However, according to specific embodiments of the invention, a logic module and/or system of the invention can provide a denial response to an incoming packet even if the address for the packet is directed to a computer that does not actually exist. Thus, an unauthorized user scanning for active IP addresses will find so many IP addresses that, depending on how much of the IP address space was scanned, the attack may be overwhelmed from too many positive replies.

Deceptive Responses

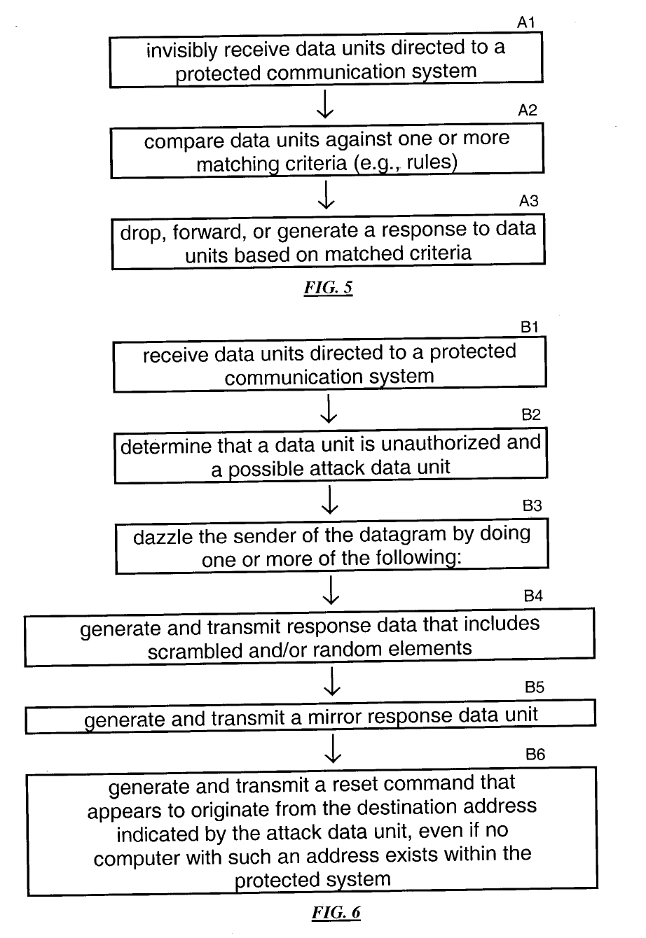

According to specific embodiments of the invention, one or more distinct deceptive responses can be provided to an incoming packet. FIG. 6 is a flowchart illustrating a general method for providing counter actions against attacking information systems according to embodiments of the present invention.

Mirror Packets

This command transmits a packet back to its sender while flipping one or more of the sending and receiving MAC, IP, and PORT values of the packet. Generally, the packet is transmitted out of the same interface where it arrived and thus this command can be used on a logic module according to specific embodiments of the invention that has only one network interface. This type of response can cause an attacker to potentially connect back to their own computer system and possible divert any malicious action back at the attackers own computer system.

In specific applications, an IR can allow one or a few address/ports to pass into the real system, while all the other ports mirror the sender.

Redirect and Reverse

These two commands are described herein together. The redirection sends packets off to another interface but in the process changes their destination IP address so they can be redirected to a computer with a different IP address. The reverser takes responses from that redirected destination and undoes the redirection for return packets so that they go back to the sender as if they came from the IP address they thought they sent the original packets to. This, of itself, provides substantial deception. However, according to specific embodiments of the invention, an IR can be configured to allow certain ports to go one way and other ports to go another way. Thus these commands provide a means for a configurable IR according to specific embodiments of the present invention to be configured to perform one or more of the redirection methods as described herein and in above referenced documents and patent applications.

Broadcast Pings

If an IR is on the same LAN as an attacker or if a LAN has a connection (such as a router) that allows an external attacker to send a broadcast packet, the attacker can attempt things such as broadcast ping or UDP packets to try to evade the IR's deceptions. Therefore, according to specific embodiments of the invention, an IR is able to provide proper broadcast responses that can indicate multiple systems on a network, even if those systems do not exist.

Dazzle

This sends packets back to the sender as if the sender had made a valid connection and was getting a valid response—except that the content is encoded and/or scrambled. Incoming packets that meet one or more criteria are responded to with pseudo-randomly generated response packets. For example, if an attacker telnets into 10.1.0.*, the attacker will get a connection (of a sort) and the connection will likely confuse the sender's display and/or the sender will not be able to understand it. However, it will appear as though the sender connected to something, perhaps being perceived by an attacker as the wrong baud rate.

In a further example, a dazzle response can be run with a probability that the dazzlement transmissions will disconnect on any given packet exchange. Thus, if the sender is in a telnet session or some such thing, the sender will get hung up till they force themselves out. And if they are trying to do open port flooding they will have an infinite number of tries before the IR fails to respond. Because many automated attacking programs have their own limits, this response can break the attacking programs and/or cause a failure in the operating systems they run on.

Concealment Responses

Concealment responses (also referred to in earlier work as Florsheim Options) allow a hidden network to piggyback on a real or exposed network in such a way as to go undetected by outsiders (and uninformed insiders). Using such responses, packets from a hidden network are inserted into the outgoing packet stream of packets from an exposed network with ports and IPs address translated appropriately so as to match those in the exposed network. Responses from the external network are separated back out with only specific responses to packets from the hidden network going to the hidden network and all other packets directed to the exposed network. Thus, any packets directed to an IP address that is “sniffed” from a hidden network packet will be received only at the exposed network.

Spoofing Transposition

Spoofing translation/transposition provides the means for an IR to completely change the source and destination addresses, ports, and MAC address associated with packets and then reverse that process for the return trip. This means that coming from 1.2.3.4:17:1:1:1:1:1:1 to 5.6.7.8:654:f:f:f:f:f:f, the IR can make it look like coming from 8.34.32.67:567:4:5:6:7:8:9 to 87.65.54.43:8765:6:3:45:f4:76:3:4 on output. The reverse process can be done on the way back. According to specific embodiments of the invention, an IR can spoof by modifying one or more of, for example, source IP address, source port, source MAC address, destination IP address, destination port, destination MAC address.

According to specific embodiments of the invention, spoofing is accomplished by in essence changing the source and destination fields by an offset. For example, an IR can be configured to translate a whole class B address space into another class B address space by offsetting all of the addresses by the difference between the two class B address spaces. From 10.2.*.* to 10.25.*.*, the translation is to add 23 to the class B field of the address space.

According to specific embodiments of the invention, for spoofing MAC addresses, there is an added feature. In order for a spoof to really do the right thing, the MAC address of return packets from one interface should be the same as those of a different interface. For example, if eth0 was being used to fake the IP addresses of eth1 computers, the return MAC addresses would have to be those of eth1, and this could not be specified as a simple offset. A+/− type indicator on MAC addresses is used to indicate whether MAC address replacement takes place before or after the transposition. So, in this embodiment, the invention uses −eth1 for the spoofed MAC address and the IR replaces the MAC address with that of the host of the same IP address on a different interface.

Probabilistic Responses

In further embodiments, a logic module and/or system according to specific embodiments of the invention can provide one or more probabilistic responses to packets, e.g., for the purpose of confusing attackers. These probabilistic responses can be understood as options to any of the standard or deceptive responses described above. Thus, the following responses/options allow an IR according to specific embodiments of the invention to be configured with a variety of packet responses that due to their strangeness tend to confuse or slow various protocols, in particular protocols or methods for attacking computer systems.

According to specific embodiments of the invention, a logic module and/or device can be configured to ignore packets with some regularity or randomly and can be used with any of the other responses described herein. In specific embodiments, every nth packet can be set to be ignored. In other embodiments, a number of packets will be responded to with a response as indicated above followed by a number that are ignored. Packets or groups of packets can also be ignored according to one or more random or pseudo-random number sequences. In further embodiments, other responses, such as mirror and dazzle, can be combined or alternated in similarly probabilistic ways.

Lower Layer Address Responses Rules and/or Options:

According to further specific embodiments of the invention, the invention can provide one or more responses that employ deceptive and/or probabilistic responses at a lower layer protocol of a packet, for example by altering MAC address of Ethernet packets. These responses/options are intended to provide appropriate consistency or (in)consistency for attackers who are detecting such things. For example, a generate random MAC address option can be combined with other responses and uses a pseudo-random number generator (PRNG) to generate a MAC address for every various packets (e.g., ARP requests).

In further embodiments, responses according to specific embodiments of the invention can have MAC addresses set flexibly to provide any type of MAC address space desired. These options can further be specified so that every source IP address included in a response is coupled with a consistent and continuous MAC address.

Other Responses

According to specific embodiments of the invention, an IR module or device can include other responses such as responses allowing for control or management of IR functions.

3. Placement in Network Environment

An IR device and/or method according to specific embodiments of the invention can be incorporated in a network in a number of ways to provide one or more of the features described herein. In specific embodiments, for example, an IR can be a logic system and/or module that simply sits within a network environment and is programmed to identify particular data packets and respond in one or more ways described below to defend against those packets. Generally, this function will be provided within a particular protected network and can be set to respond to packets identified as “bad packets” in some way or the response functions can be provided to all unauthorized packets. As used here and throughout this discussion, packet should be understood to indicate any type of data communication unit that is transmitted on a data communication system. More specifically, a packet is a data unit that includes or is associated with a destination address indication.

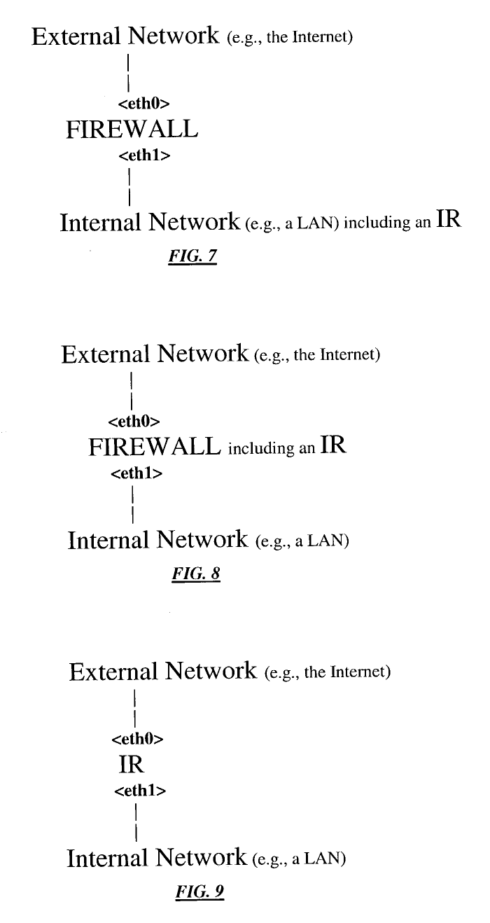

A simple configuration is illustrated in FIG. 7. Note that in this example, an IR according to specific embodiments of the invention does not act as a firewall between the external and internal network environment and thus cannot provide filtering functions such as deny or ignore. However, even in this simple configuration, an IR according to specific embodiments of the invention can perform a number of deception operations, such as dazzle and/or mirror in response to packets received at the IR. In this figure, <eth0> and <eth1> can be understood as network interface connections, which, for example, in Unix/Linux based systems may be referred to as “devices.” In this particular example, the names indicate Ethernet connections, but any network connection can be used with specific embodiments of the invention.

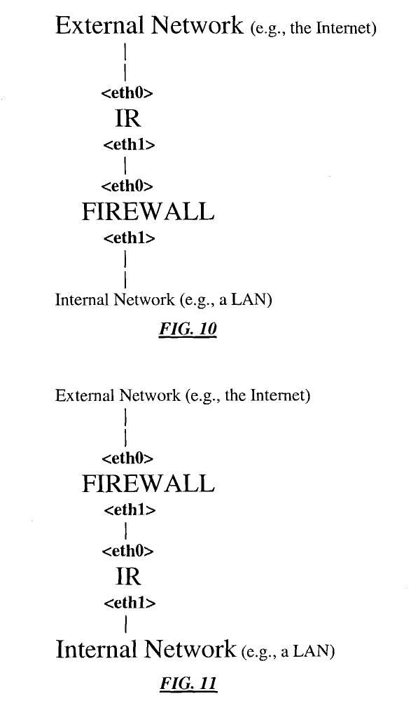

In further embodiments, an IR will be configured to sit between an external network, essentially in the same space as a firewall. In such an embodiment, an IR can perform additional deception functions as well as filtering functions. In such an embodiment, an IR can be embodied as one or more logic modules within a traditional firewall system or can be used instead of a firewall system, or can exist as a separate system just behind or just outside of a firewall. Four simple examples of this configuration are illustrated in FIG. 8 through FIG. 11.

In the just preceding examples, the IR essentially acts as a two-interface device creating two network domains from the perspective of the IR, though external devices are generally not aware of the presence of the IR and therefore perceive just one network domain.

In further embodiments, an IR according to specific embodiments of the invention can include additional network interfaces to additional separated network domains. Again, according to specific embodiments of the invention, only the IR itself may be aware of these separate domains and all other network entities will not generally perceive these separate domains. One additional domain provided by an IR can for example be a redirect domain. Such a redirect domain can include one or more deception systems that mock the behavior of a real network. Using such a method, an IR can cause an attacker to perceive that they have accessed a real protected network, when they have in fact only accessed one or more deception machines.

Further Topologies for Network Protection

According to specific embodiments of the invention, the invention involves one or more novel network topologies that can be used with an IR and/or other network device to provide enhanced network functionality.

One example topology according to specific embodiments of the invention is referred to herein as a four-interface topology or NSEW topology. In one example of such a topology using an IR, the IR would sit between two LANs or between a LAN and a gateway computer or external network. FIG. 12 illustrates an example communication configuration showing a network device according to specific embodiments of the invention configured as a device separating an internal network from an external network and providing for one or more additional networks and having at least three communication interfaces. The diagram and the related discussion can be understood using a NSEW terminology as follows:

North: Indicates data communication devices and/or systems and/or networks in the rest of the world, e.g., all information systems and or networks that can communicate data up to where an IR is connected but that are not being ‘protected’ or otherwise affected by the IR.

South: A ‘protected’ portion of the network (e.g., a LAN) that generally otherwise operates normally and that, for example, an IR can make less susceptible and/or responsive to attacks.

East: An optional ‘deception’ or redirection network environment that can be kept separated from the South environment and can be used for such things as providing honeypots, providing emulated networks, providing false response, etc. Note that in specific embodiments, an IR can internally generate one or more deceptive responses. However, a redirection into a redirected network can allow for a more rich and real-time set of deceptive responses.

West: Can be understood as either another optional redirection network and/or an optional traffic generator (TG) network portion used if a traffic generator is desired to create false traffic.

Control: An optional Control portion (e.g. a LAN or other interface) can be used if a separate control plane is desired for external IR control. This separate interface may be included in order that an IR and/or similar device can be truly “invisible” to all other ports.

Operation according to such a topology according to specific embodiments of the invention can be understood as follows:

| Data | | |
|---|---|---|
| Traffic | Type of Traffic Detected at | |
| Direction | IR or similar device | Action Taken |
| From North | Authorized systems (IPs) | Traffic directed South to have those |
| | using authorized services | services rendered |
| | (ports) | |
| | Unauthorized systems or | Traffic handled based on the deception |
| | authorized systems using | configuration |
| | unauthorized services | |
| From South | Authorized systems (IPs) | Traffic forwarded to authorized requesters |
| | rendering authorized services | (e.g. authorized IP addresses) from North |
| | (ports) | |
| | Unauthorized systems or | Traffic handled based on the deception |
| | authorized systems using | configuration. |
| | unauthorized services | |
| From East | | Traffic is directed North, South, or West, |
| | | depending on the address information |
| | | associated with the deception operation in |
| | | use |
| From West | | Traffic being deceived and sent to the |
| | | West for that purpose has return traffic |
| | | returned to the interface it came from |
| From | Traffic from authorized IP | Traffic is forwarded to a secure shell |
| Control | addresses and ports to | session on the IR to allow control to be |
| | authorized IP addresses and | carried out |
| | ports | |
| | All other traffic is ignored | |

In the above described operating mode, an IR according to specific embodiments of the invention can be thought of in a similar manner to a firewall where ‘North’ is the outside and South is the inside, but according to specific embodiments of the invention, an IR does some very different things than most firewalls. One of the big differences is that the IR uses deception rather than simply dropping and logging all unauthorized packets. Another major difference is that the IR operates to protect insiders from ‘bad’ insiders as well as to protect insiders from outsiders.

For example, if it has been identified that TCP traffic from 10.2.3.4 to 10.2.3.5 on South is not authorized, the IR can cause attempted traffic of this sort in the South network to fail to operate correctly. In other words, while an IR according to specific embodiments of the invention may not do as well at protecting insiders from other insiders as it will for protecting insiders from outsiders, it does provide an effective defense in many cases.

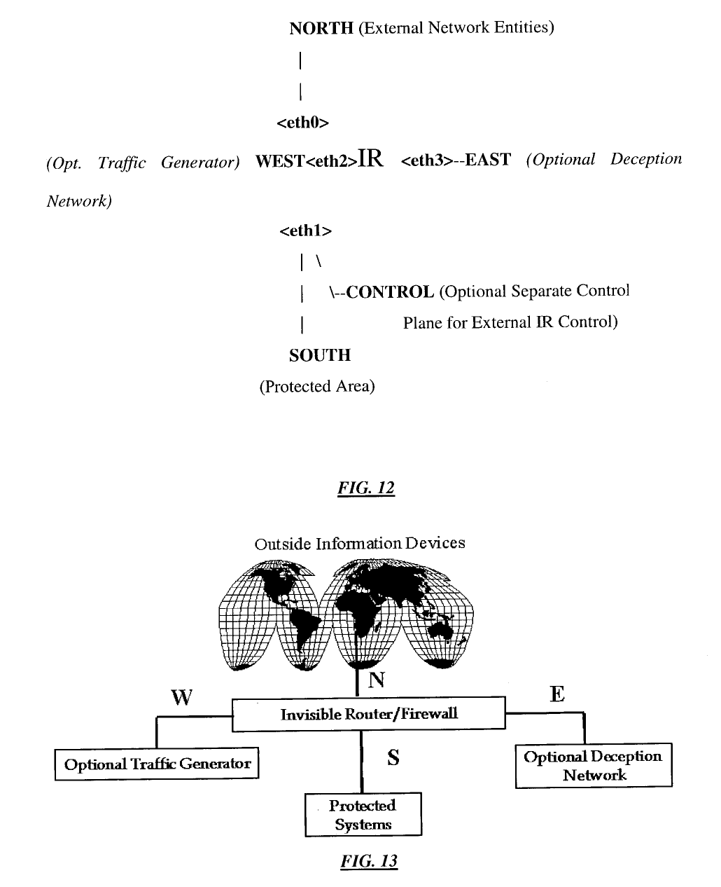

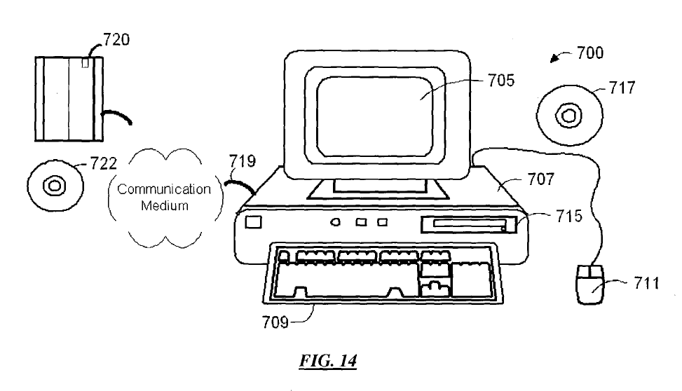

A further detailed example network topology diagram useful for discussion of aspects of specific embodiments of the invention is shown in FIG. 12. In this drawing, a central IR is shown, with three communication interfaces (for example Ethernet interfaces) which are labeled herein, eth0-eth3. The four network domains connected to the router are designated NORTH, SOUTH, EAST and WEST. FIG. 13 illustrates an example configuration of an application of the present invention for protecting one or more information systems.

4. Modes of Operation in Specific Embodiments

According to specific embodiments of the present invention, a logic system according to the invention can include a number of separate modes of operation. In specific embodiments, operation can be affected by a user through one or more interfaces, e.g., text-based or graphics-based displayed menus, telephone menus, command line configuration, configuration file configuration, etc. While these modes and interfaces provide flexibility of configuration in some implementations, other embodiments of the invention need not provide for separate modes of operation.

Bridge Mode

In bridge mode, a system and/or method of the invention generally passes all packets between an “outside” and a “protected” network environment with the possible exception of packets from control IP addresses on a Control Interface (which may be identical to a protected environment interface in some networks) to the IR's control addresses. In specific embodiments, these can be forwarded to an ssh listener designed for remote control of the IR from network management systems. Bridge mode is selected as the default mode according to specific embodiments of the present invention so that if no other configuration action is taken, an IR does not appear to exist and traffic is not inhibited.

Bridge Mode Example User Interface

An example text-based user menu interface in bridge mode is provided below. It will be understood that this is a simple example and that many other user interfaces can be used in specific embodiments of the invention. The invention can also not provide for a user interface and be hard-wired to operate in specific modes or be configured using data configuration techniques as known in the art such as a configuration file, ROM, PROM, etc. Similarly, other menu interfaces and/or data interfaces can be used to configure the list of ‘good’ and ‘bad’ IP addresses and to configure gateway information if a gateway computer is being used at the outside network interface.

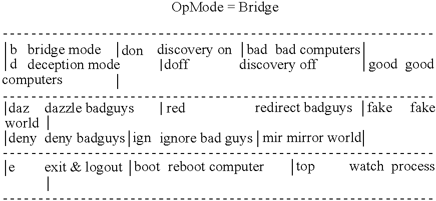

Deception Mode

In deception mode, an IR operates as further described herein to provide one or more operations including one or more deception operations. Various embodiments of the invention can provide for various groups of deception operations.

As an example, in deception mode, deny specifies that ‘identified bad IPs’ are denied by the IR and in particular are not passed from the outside network to the protected network. Generally, in contrast to ignore, some type of denial message may be sent back to the denied IP address. This is much like the operation of a normal firewall and is not truly “deceptive” as further described herein.

As a further example and according to specific embodiments of the invention, in deception mode dazzle indicates that an IR is to perform some dazzlement functions.

According to specific embodiments of the invention, deception operations can be understood as falling into one of four groups:

redirect Redirects unauthorized and/or identified packets to a different network environment from the general protected environment.

ignore Ignores unauthorized packets generally without providing any response. This gives the appearance that the addressed system does not exist.

fake Produces some type of direct deceptive response (e.g., ‘Dazzle’) on identified bad and/or unauthorized IPs. As discussed below, some types of fake responses are more active than others and may be reserved for only identified bad IP addresses.

mirror Use the mirror function on identified bad and/or unauthorized IPs.

As an example of redirect, by configuring devices in a redirect network or system to have the same IP addresses and system types as devices in a protected network computers, unauthorized access attempts will be redirected toward false computers in the redirect network space occupying the same IP address space as computers in the protected network.

Discovery Mode

In a discovery mode in specific embodiments, machines in the protected network environment are assumed to be doing network mapping operations and, as such, are authorized to send and receive packets to and from an outside network environment without limit on identified ports and address ranges. This makes the deception highly susceptible to subversion because in network discovery mode the ‘true’ network state is being displayed at both the outside network interface and protected network interface.

5. Further Detailes of Example Responses and Example Syntax

The previous discussion describes several novel methods and/or systems in a data communication network that can be used to enhance network security through deception. A number of different methods and/or systems will be understood to those of skill in the art for effecting these methods and/or systems using the descriptions provided above. Further details of specific embodiments of systems including a novel syntax for network functionality and novel methods and/or systems for effecting network functionality using rule sets are described below. While these further details describe further novel elements, the methods of the invention described herein can be implemented using any logic system, such as, but not limited to objected oriented programming, linear programming, etc. Methods and systems of the invention are also not restricted or limited to any particular syntax for describing actions taken by an IR, but the particular syntax described below has proved to have advantageous in particular implementations.

Syntax for Describing Network Addresses

The present invention, in further specific embodiments, provides a syntax that is useful for describing network states and responses to network states. This syntax has a number of network configuration and/or programming applications. In one embodiment, a syntax according to specific embodiments of the invention provides a means for succinctly describing ranges of network addresses. In a further embodiment, the syntax provides a means for succinctly describing various responses to network addresses. In the description below, a syntax according to specific embodiments of the invention is described in the context of rules-sets for a rules-based embodiments. It will be understood that this is by way of example and other applications for a syntax according to specific embodiments of the invention will be understood to those of skill in the art.

Rules and Rule Sets

In particular implementations, it has been found advantageous to describe actions to be taken by an IR using rules and rule sets. According to specific embodiments of the present invention, a system programmer and/or designer creates sequences of rules indicating how to handle data units received and/or detected an in IR module based on matching a stimulus to a rule and generating a response. In specific example embodiments, rules are specified according to particular network interfaces of an IR. An IR acting within a protected network may have just one interface; an IR acting to separate external network devices from a protected network will generally have at least two interfaces; an IR that can also redirect traffic to a redirection network will generally have at least three interfaces; and an IR that can further also receive traffic from a traffic generating system or network may have at least four interfaces. In a specific example embodiment used herein for discussion purposes, each IR interface is associated with Ethernet interface logic (e.g., Ethernet cards) and each interface can also be referred to as an Ethernet interface. Thus, interfaces are referred to at times herein as<eth0>, <eth1>, <eth2>, etc. Furthermore, in a Unix/Linux operating system environment, interfaces are handled in a similar way to other input/output devices. Thus, the designation <dev> or device or devicename is also at times used to indicate a network interface of an IR as will be understood from the context. This specific use of the designation <dev> is not intended to limit the more general definition of device used throughout this application.

Thus, in a general example, packet rules for each interface are grouped together. Generally, rules are examined sequentially. In a typical operation, if a rule matches an incoming packet, no more rules will be examined. However, in specific embodiments, an IR can be configured to continue checking all rules even after a match is found and/or after performing a desired action.

For purposes of discussing rules and specifying rules using a text-based editor on a computer system, it is helpful to define a syntax for rule expression. In the discussion below, the three characters ; { } are example delimiters for larger rule sets. However as with all delimiters and character indicators used below, different characters can be substituted in any rule definition to achieve the same functionality according to specific embodiments of the invention. According to specific example embodiments of the present invention, for each separately controlled logical interface(s), the rule set is of the form: devicename {[<rule>;]+} where devicename indicates one or more interfaces (e.g., eth0-ethn or atm0-atmn, etc., or any other name used to indicate a communication interface of any protocol from which data units are sent and/or received} and where <rule> is as defined below and [<rule>;]+ indicates that one or more than one rule may be used in a rule set, each rule ending with a ‘;’.

According to specific example embodiments of the present invention each <rule> can be understood as being of the form:

[<Protocol>]<Source><Destination>[<Option>]<Response>[<argument>];

While there can be any desired number of spaces or tabs between rule elements, in a specific embodiment all of the above should be on one line and have separating spaces between fields but not within them. The syntax does not need a separator for the semicolon, and one can put hard returns between rules as well as blank lines and comment lines (e.g., lines starting with ‘#’).

Some fields are required and others are optional—depending on the circumstance. Portions of the syntax above enclosed in [ ] indicates fields that have optional components in specific situations. Thus, note that in this syntax a rule with no optional elements will have the form:

<Source><Destination><Response>;

However, note also that is other syntaxes, rules may be specified using only a source or destination address and thus have the forms:

<Destination><Response>; or

<Source><Response>.

According to specific embodiments of the invention, such a rule indicates that for any packet matching the <Source> and <Destination> address portions, the <Response> will be taken. Specific example syntaxes for writing each of these portions are described below.

Protocol Syntax: (<Protocol>)

According to specific embodiments of the invention, a rule can be identified to be limited to one or several protocols. For example, a rule may apply only to SNMP data units. Any designation can be to indicate different protocols. Examples of protocol designations include ARP, ICMP, TCP, UDP or E or nothing for everything.

Network Address Syntax: (<Source> and <Destination>)

As described above, the invention in specific embodiments is directed to a network device and/or logic module (the IR) that provides a novel level of flexibility in responding to network packets. In order to allow a system programmer and/or configurer to specify the flexible response behaviors of an IR according to specific embodiments of the invention, in further embodiments the invention involves a novel concise syntax for specifying meaningful ranges of network addresses as well as for specifying responses to network packets. Details of an implementation of such a syntax are provided below.

Example <Source> and <Destination> Syntax

According to specific embodiments of the present invention, the <Source> and <Destination> fields have the same syntax and are discussed together. According to specific embodiments of the present invention, they have the form:

<Source>|<Destination>:=<IPRangeSet> [:<Class>] [:<PortRange>]

which can be understood as an IP address range set, an optional delimited (e.g., a “:” in the above or an implied delimiter) followed by a network class, and an optional : followed by a port range.

Going from simpler examples to more complex examples:

<PortRange>:=[!]<fromport-endport>|[!]<port>

A port range is a range of ports (inclusive) to which this rule applies. To have a rule apply only to port 80 (the http protocol port), using this specific syntax, write something like: 10.0.0.1:80-80 or 10.0.0.1:80. This means that from port 80 to port 80 apply to this rule. A second example is: 10.0.0.1:0-65535. In this case, the ‘-’ indicates all ports from 0 thru 65535. In specific embodiments, 0-65535 can be understood as a default for port ID and it is selected if a port range is not specified. Use the ‘!’ character (NOT) to select all but the specified range for one portion of a <Source> and/or <Destination> fields.

<IPRangeSet>

The <IPRangeSet> (IP address range set) allows specifying a number of IP addresses in one statement. An example syntax:

<IPRangeSet>:=[˜]<IP>|[˜-]<IP>+<IP>|

[˜]<range>.<range>.<range>.<range>

where <IP>:=<IP-Part>.<IP-Part>.<IP-Part>.<IP-Part>

where <IP-Part> e.g., a decimal number between 0 and 255 inclusive

where <range>:=[!]<IP-Part>|[!]<IP-Part1>-<IP-Part2>|*

where <IP-Part1> is a decimal number between 0 and 255 inclusive and less than or equal to <IP-Part2> which is a decimal number between 0 and 255 inclusive;

where ‘!’ is a subpart negation indicating everything except this range for a subpart of the address;

where ‘*’ indicates all valid values for this part, e.g., 0-255;

where ‘˜’ is an address negation indicating everything except the addresses indicated by the address expression.

Below are further examples:

$$\begin{matrix}1.2 .3 .4 & The single IP address 1 .2 .3 .4 \\ 3.4 .5 .6 + 245.128 .76 .89 & All IPs from 3 .4 .5 .6 thru \\ & 245 .128 .76 .89 inclusive \\ ∼ 3.4 .5 .6 + 245.128 .76 .89 & All IPs except 3 .4 .5 .6 thru \\ & 245 .128 .76 .89 inclusive \\ 10.2 .3 - 240.7 - 89 & 10.2 . \text{<} any {3}^{rd} digit between 3 and \\ & 240 inclusive \text{>} . \\ & \text{<} any {4}^{th} digit between 7 and 89 \\ & inclusive \text{>} \\ ∼ 1.2 .3 .4 & Every address except the single IP \\ & address 1 .2 .3 .4 \\ ! 1.2 .3 .4 & Every address ending in 2 .3 .4 with \\ & the first digit not 1 \\ 10.2 . ! 3 - 99.7 & 10.2 \text{<} any {3}^{rd} digit except 3 thru 99 \\ & inclusive \text{>} .7 \\ 10.2 .3 {.}^{*} & 10.2 .3 .0 - 255 \\ 0.0 .0 .0 + 255.255 .255 .255 & All the IP addresses there are \\ 0 - 255.0 - 255.0 - 255.0 - 255 & The same thing in a different format \\ 0.0 .0 .0 \text{:} e & The same thing in a different format \\ {}^{*} {.}^{*} {.}^{*} {.}^{*} & The same thing in a different format\end{matrix}$$

<Class>

The network class field (<Class>) allows saving some effort in writing some of the IP address ranges that are most commonly used, for example <Class>:=[E|A|B|C|D] ignores the last all3/2/1/or 0 bytes of the IP address respectively. So, for example:

10.2.3.4:E indicates all IP addresses—E stands for Everything

10.2.3.4:A indicates all IP addresses starting with 10.

10.2.3.4:B indicates all IP addresses starting with 10.2

10.2.3.4:C indicates all IP addresses starting with 10.2.3

10.2.3.4:D indicates exactly one IP address . . . 10.2.3.4

!10.2.3.4:B indicates all IP addresses except the class B address space starting with 10.2.

Further embodiments can include a scripting syntax or meta-syntax that allows an operator to specify a group of related rules that are then automatically generated. For example, a meta-syntax expression might look something like:

10-12.5.3,4,6,7,9,12,34.12-45,!78-90,123.

This expression is then used to automatically generate a set of matching expressions that cover all the specified rules.

As a further overall example including elements of the previous discussions, consider:

AIT 10.0.0.0:B:23-23 10-12.0.2-3.4:1-340 [Options]<Action>; This indicates all ARP, ICMP, and TCP packets from IPs 10.0.*.* on port 23 to IPs 10.0.2.4, 11.0.2.4, 12.0.2.4, 10.0.3.4, 11.0.3.4, or 12.0.3.4 on ports 1 thru 340 inclusive.

Under specific embodiments of the invention, other ways to indicate the same address range using an example syntax according to the invention:

AIT 10.0-255.0-255.0-255:23 10-12.0.2-3.4:1-340 [Options]<Action>;

AIT 10.0-255.*.*:23 10-12.0.2-3.4:1-340 [Options]<Action>;

AIT 10.*.*.*:23 10-12.0.2-3.4:1-340 [Options]<Action>,

6. Responses and Syntax for Describing Responses

Response Descriptions and Syntax: (<Response>)

The following describes both a particular syntax for expressing responses of an IR according to specific embodiments of the invention. It will be understood that the various responses described below are independent of any particular syntax used to express them. It will be further understood that the responses can be implemented in a logic system using a variety of different logic manipulation and/or programming techniques.

In a particular example rules-based IR system, the <Response> part of a rule is a basic mechanism that the IR uses to form responses. In specific embodiments, options can be used to indicate enhancements to some of the responses and various example options are discussed below. In further specific embodiments of the invention, a <Rule> according to specific embodiments of the present invention can be described using the syntax:

<Rule>[<Protocol>]<Source><Destination>[<Option>]<Response>[<argument>];

According to specific embodiments of the present invention, a <Response> portion of the rule can have the example forms listed below. Following the list, these example responses are discussed in further detail.

| <Response>:= | I | Ignore the packet |
|---|---|---|
| | D | Deny the packet |
| | F <dev> | Forward the packet to the indicated device/interface |
| | M | Mirror the packet |
| | R <IP> [port] <dev> [<dev>] | Redirect the packet with a new |
| | | address/port out of one or more |
| | | devices/interfaces |
| | V <IP> [port] <dev> [<dev>] | Reverse redirection with a new |
| | | address/port out of one or more |
| | | devices/interfaces |
| | B <IP> <range> | Broadcast response |
| | Z <prob> | Dazzle the sender |
| | Y <dev1> <dev2> | Concealment mode (external) |
| | H | Concealment mode (hidden) |
| | E | Concealment mode (exposed) |
| | L | Loopback interface forwarding |

T <sIPm><sPm><sMm><dIPm><dPm><dMm> <dev> Transpose/

Spoof IPs, ports, MACs

I: Ignore

In an ignore response, there is no response to a packet and the packet is not forwarded out of any other IR interfaces. With a command such as eth0 {*.*.*.**.*.*.* I;}, an IR according to specific embodiments of the invention will ignore all packets received on the indicated device (e.g., eth0), e.g. as if the IR and all the machines behind the “firewall” of the IR do not exist. In this case, a packet watching program such as TCPDUMP could be used on the IR computer as a ‘silent’ observer. In this configuration, an IR should not be detectable except perhaps by a time domain reflectometer. This command can also be used as the last rule so that no matter what else the IR does, if the previous rules did not apply, this is what the IR will do. Thus, according to specific embodiments of the invention, this is a default last rule for an IR on every interface; however, a user may want a reduced set of IP addresses or ports. As a further example, consider eth0 {AI *.*.*.* 10.0.0.0:a I;}, which will ignore all ARP and ICMP packets from anywhere on eth0 to IP addresses in the 10.* address space. This means that, even though packets could pass through, pings and other ICMP packets will not pass through and ARP addresses will not appear to exist for these machines.

D: Deny

Deny the packet by, for example, sending a ‘reset’ response to the sender. This is a reset flag in a TCP packet. This causes most systems to stop sending packets to a particular destination address, but it will also indicate that the IP address associated with the port exists and allow port scanners to find the ‘computer’ on that address—even if no such computer actually exists. This is one “dazzle” technique according to specific embodiments of the invention. Consider the example: eth0 {*.*.*.**.*.* D;}. With this example, every port on every IP address in the whole world seems to exist, but all of them are refusing to serve an unauthorized user (e.g., a user whose incoming packets have not triggered a response on an earlier rule). If such an unauthorized user does a scan of these computers with something like NMAP, an attacking or computer discovery program may find so many ports and IP addresses that, depending on how much of the IP address space was scanned, the program may crash from too many positive replies. As a further example in UDP, deny mode can send an ICMP “port unreachable” message for a closed UDP port.

F: Forward to Another Device/Interface

This is the normal routing sort of function described above. It copies incoming packet to an outbound interface, generally as if the IR was not there and a direct connection (e.g., a cable) was there instead. Even this command, according to specific embodiments of the invention, can do interesting things when options are added. For example, this rules forwards all packets on eth0 to eth1—a simple one-way wire—without another rule to forward back responses, the IR works like a digital diode in this case—without the hardware surety of a real digital diode. An example:

eth0 {*.*.*.**.*.*.* F eth1;}

M: Mirror Packets

This command mirrors a packet back to its sender. Mirror flips the sending and receiving MAC, IP, and PORT values of the packet and transmits the packet out on the interface it arrived on. So, for example: eth0 {*.*.*.**.*.*.* M;}, causes all attempts to send packets into eth0 to act as if they were emitted from eth0 toward the computers attached, either directly or indirectly, to that device. If someone tries to telnet into another IP address, the mirror will reflect the request back and try to telnet them back into their own computer. If they have left telnet open on their computer, they will be telnetting into themselves. They might even succeed at breaking into themselves, and perhaps go a lot further—like deleting all of the files on their own system—before they notice that they are both the attacker and the victim. The following example is a bit more complex:

eth0 {*.*.*.* 1.2.3.4:21385 F eth0;

*.*.*.**.*.*.* M;}

This rule set has two rules in sequence. In experiments involving the current invention, attackers sometimes learned to ignore computers that mirrored them by setting up a fake port on their own machine and using it to detect incoming connection attempts from any computer they tried to scan. If they found it was mirroring they would ignore the whole computer. In this example, an IR allows one port to pass into the real system, while all the other ports mirror the sender. Unless the sender guesses very right, they will ignore the real entry point. However, this rule used alone might be easy for an attacker to detect and thus the current invention according to specific embodiments provides other commands and options allowing an IR configurer to add further complexity in responses.

R: Redirect the Packet &

V: Reverse the Redirection

These two commands are described herein together. The redirection sends packets off to another interface but in the process changes their destination IP address so they can be redirected to a computer with a different IP address. The reverser takes responses from that redirected destination and undoes the redirection for return packets so that they go back to the sender as if they came from the IP address they thought they sent the original packets to. So this allows an IR to forge IP addresses at will, for example:

eth0 {1.2.3.4 5.6.7.8 R 12.13.14.15 eth1;}

eth1 {12.13.14.15 1.2.3.4 V 5.6.7.8 eth0;}

This pair of rules will redirect all packets from 1.2.3.4 intended for 5.6.7.8 to the real system 12.13.14.15 and allow responses from 12.13.14.15 going back to 1.2.3.4 to appear to come from 5.6.7.8. This, of itself, provides substantial deception. However, according to specific embodiments of the invention, an IR can be configured to allow certain ports to go one way and other ports to go another way, for example:

eth0 {1.2.3.4 5.6.7.8:23-23 R 12.13.14.15 eth1;

1.2.3.4 5.6.7.8 F eth2;}

eth1 {12.13.14.15:23-23 1.2.3.4 V 5.6.7.8 eth0;}

eth2 {5.6.7.8 1.2.3.4 F eth0;}

In this example, if the real 5.6.7.8 is on the eth2 interface, it will get all of the packets it is supposed to—except the ones going to port 23—normally the telnet port. These will go to 12.13.14.15 on eth1.

In addition, a user can redirect to both a specified IP and a specified port. To do this, specify a single source IP:port pair (no mulitplicity), and a single destination EP:port pair. Using the format: ‘R A.B.C.D N’ the TCP or UDP packet matching the source and destination of the rule will have its destination port replaced by N. On the reverse, the source port will be replaced by N, completing the port redirection. For example:

eth0 {1.2.3.4:1024 9.8.7.6:23 R 9.8.1.1 22 eth1;}

eth1 {9.8.1.1:22 1.2.3.4:1024 V 9.8.7.6 23 eth0;}

A computer tries to connect to port 23 on 9.8.7.6, but the IR redirects this request to 9.8.1.1 port 22 on eth1. When the computer 9.8.1.1 replies on source port 22, the IR replaces the IP and port with what 1.2.3.4 expects . . . 9.8.7.6 port 23. Note that in this example, the port indication after the R and V commands are arguments and in this case are delimited with a space.

Thus these commands provide a means for a configurable IR according to specific embodiments of the present invention to be configured to perform one or more of the redirection methods as described herein and in referenced documents.

B: Broadcast Pings

If an IR is on the same LAN as an attacker or if a LAN has a connection (such as a router) that allows an external attacker to send a broadcast packet, the attacker can attempt things such as broadcast ping or UDP packets to try to evade the IR's deceptions. Therefore, according to specific embodiments of the invention, an IR is able to provide proper broadcast responses to the whole network. For example consider the response indicated by the rule below:

eth0 {10.0.0.0:c 10.0.0.255:d B 10.0.0.1+10.0.0.34;

10.0.0.0:c 10.0.1.127:d B 10.0.1.!1-34;}

would respond to broadcast pings with IP addresses 10.0.0.1-34 showing as alive and broadcasts to the 10.0.1.127 7-but broadcast range would respond on all IPs 10.0.1.<anything but 1-34 inclusive>. In the ‘C’ option discussion elsewhere herein provides description of how this command can be further used.

Z: Dazzle

This sends packets back to the sender as if the sender had made a valid connection and was getting a valid response—except that the content is encoded and/or scrambled. For example, the simple instruction eth0 {10.1.0.0:c Z;} responds to all incoming packets of whatever type with pseudo-randomly generated response packets. For example, if an attacker telnets into 10.1.0.*, the attacker will get a connection (of a sort) and the connection will likely confuse the sender's display and/or the sender will not be able to understand it. However, it will appear as though the sender connected to something, perhaps being perceived by an attacker as the wrong baud rate.

In a further example, eth0 {10.1.0.0:c Z 128;} with the added 128 parameter provides a probability (out of 255) that the dazzlement will disconnect on any given packet exchange. In this case, there is a roughly 50/50 chance that the exchange will run for one packet each way, and of the remaining sessions a 50/50 chance that it will go for another packet, etc. The default (as above) is 0—which is to say that the seeming ‘connection’ will never close until the sender gives up. So if the sender is in a telnet session or some such thing, the sender will get hung up till they force themselves out. And if they are trying to do open port flooding they will have an infinite number of tries before the IR fails to respond. Because many automated attacking programs have their own limits, this response can break the attacking programs and/or cause a failure in the operating systems they run on.

Y, H(idden), and E(xposed): The Concealment Responses

Concealment responses (also referred to in earlier work as Florsheim Options) allow a hidden network to piggyback on a real or exposed network in such a way as to go undetected by outsiders (and uninformed insiders). For example:

eth0 {0.0.0.0:e 10.2.3.0:c Y eth1 eth2;}

eth1 {10.2.3.0:c 0.0.0.0:e H;}

eth2 {10.2.3.0:c 0.0.0.0:e E;}

In this example, the eth0 connects to the outside world, and the Y command specifies that eth1 connects to the ‘hidden’ network, and eth2 connects to the ‘exposed’ network. The H command specifies which packets from eth1 (the hidden network) are inserted into the packet stream from eth2 to eth0 with ports and IPs address translated appropriately so as to match those in the exposed network. Responses from the external network are separated back out with only responses to packets from the hidden network packets going to the hidden network and all other packets directed to the exposed network. Thus, any packets directed to an IP address that is “sniffed” from a hidden network packet will be received only at the exposed network. In this specific example, Y indicates a branching from one interface to two interfaces, with the hidden network specified first, followed by the exposed network and H and E are used to indicate the address translation in the outgoing direction from the two networks.

L: Loopback Forwarding

In some cases, for example remote network control applications, it may be desirable for an IR to accept incoming traffic from outside sources for internal use. This can be dangerous as it allows for the possibility that the IR will be controlled from afar or broken into. Nevertheless, the present invention provides the means for an IR user to implement this through a ‘loopback’ interface. Here's an example:

eth0 {23.34.45.65 23.34.45.23:976 L;}

This example forwards packets coming from 23.34.45.65 on any port going to 23.34.45.23 on port 976 to the loopback interface of the IR and provides for the reverse traffic from the loopback interface to 23.34.45.65 making the return traffic look as if it were coming from 23.34.45.23 on port 976. In this example, if an ssh server is configured to listen on port 976 on the loopback interface, even though there is no real IP address on the IR, the packet would do the ‘right thing’.

This command can also be used, for example, to arrange that each incoming control source had a different destination IP address and port and rig the IR to forward similar requests from other locations to a deception system—or a dazzlement of some sort.

T: Spoofing Transposition

Spoofing translation/transposition provides the means for an IR to completely change the source and destination addresses, ports, and MAC address associated with packets and then reverse that process for the return trip. This means that coming from 1.2.3.4:17:1:1:1:1:1:1 to 5.6.7.8:654:f:f:f:f:f:f, the IR can make it look like coming from 8.34.32.67:567:4:5:6:7:8:9 to 87.65.54.43:8765:6:3:45:f4:76:3:4 on output. The reverse process can be done on the way back. In order to do this for entire address ranges, the rule looks like this:

T<sIPm>[<sPm>[<sMm>]]<dIPm>[<dPm>[<dMm>]]<dev>

where:

T indicates ‘transpose’

| | |
|---|---|
| <sIPm>:= <IPm>.<IPm>.<IPm>.<IPm> | source IP modifier |
| <sPm>:= :<pm> | source Port modifier |

<sMm>:= :<mm>:<mm>:<mm>:<mm>:<mm>:<mm>|:[+/−]<dev> #source MAC

modifier

| | |
|---|---|
| <dIPm>:= <IPm>.<IPm>.<IPm>.<IPm> | destination IP modifier |
| <dPm>:= :<pm> | destination Port modifier |

| | |
|---|---|
| <dMm>:= :<mm>:<mm>:<mm>:<mm>:<mm>:<mm>\|:[+/−]<dev> | #destination |
| | MAC modifier |

| | |
|---|---|
| <dev> | a device (e.g., eth0, eth1, etc.) |

where:

| | | |
|---|---|---|
| <IPm>:= | <s><o> | address sign (+/−) and offset (0-255) |
| <pm>:= | <s><po> | port sign (+/−) and offset (0-65535) |
| <mm>:= | <s><o> | MAC sign (+/−) and offset (0-255) |

| | |
|---|---|
| [+/−]<dev>:= | +/− followed by a device/interface identifier |

The above command description can be understood by considering the following. In essence, the goal here is to change the source and destination fields by an offset. The offset is specified by + or − followed by the offset distance. As an example, for IP and MAC octets, these are in the range of 0-255, while for ports the offset can range from 0 to 65535. So, for example, an IR can be configured to translate a whole class B address space into another class B address space by offsetting all of the addresses by the difference between the two class B address spaces. From 10.2.*.* to 10.25.*.*, the translation is to add 23 to the class B field of the address space, done as follows: +0.+23.+0.+0. The return translation looks like this: −0.−23.−0.−0. Of course +0 and −0 are the same and because everything is done mod 255, the reverse translation can also be written as: +0.+233.+0.+0.

According to specific embodiments of the invention, for spoofing MAC addresses, there is an added feature. In order for a spoof to really do the right thing, the MAC address of return packets from one interface should be the same as those of a different interface. For example, if eth0 was being used to fake the IP addresses of eth1 computers, the return MAC addresses would have to be those of eth1, and this could not be specified as a simple offset. The +/− indicator on MAC addresses is used to indicate whether MAC address replacement takes place before or after the transposition. So, in this embodiment, the invention uses −eth1 for the spoofed MAC address and the IR replaces the MAC address with that of the host of the same IP address on a different interface. A simple example:

eth0 {1.2.3.4 9.8.7.6 T+0.+0.+0.+0+0.+0.+0.+0:+0:+0:+eth1 eth1;}

eth0 {*.*.*.* 9.8.7.6 F eth2;}

eth1 {9.8.7.6 1.2.3.4 T+0.+0.+0.+0:+0:+eth2+0.+0.+0.+0:+0 eth0;}

eth2 {9.8.7.6 *.*.*.* F eth0;}

From eth0, packets from 1.2.3.4 to 9.8.7.6 are forwarded to eth1 with the destination MAC address replaced by the MAC address of 9.8.7.6 on eth1 —so that no matter what the originator thought the MAC address should be, the proper MAC address for the system on eth1 is used for this packet. The second rule forwards every other source address to eth2 in the normal fashion.

For the reverse, packets coming back from eth2 are forwarded to eth0 without alteration, however, packets coming from eth1 need their source MAC address translated back to the MAC address expected for 9.8.7.6 from eth2 or there will be inconsistent MAC addresses for 9.8.7.6 on eth0. According to specific embodiments of the invention, there is a limitation to this sort of spoofing. The limitation is that the MAC addresses of machines on ports have to be cached somehow. Massive MAC forgery should be handled properly in order not to disturb the network. In addition, it is necessary to ‘prime the pump’. In order for a MAC cache to exist, an ARP request generally has to show up on both interfaces. Thus, it may be helpful to begin with rules like this:

eth0 {A *.*.*.**.*.*.* -CF eth1;}

eth0 {A *.*.*.**.*.*.* F eth2;}

eth1 {A *.*.*.**.*.*.* I;}

eth2 {A *.*.*.**.*.*.* F eth0;}

The first two rules use ‘continuation’ to forward all ARP requests and replies from eth0 to both of the other interfaces. This means that both eth1 and eth2 machines will have all of the same MAC addresses available to them and that any request for a MAC address from eth0 will be answered by machines on both eth1 and eth2. But the only answers from eth2 will be returned. This means that all of the MAC addresses associated with both eth1 and eth2 will be cached by the IR (up to some finite maximum cache size) but that only MAC addresses in ARP packets from eth2 will make it to eth0.

With the previous rules, the forgery is complete and the MAC addresses all match up at eth0 while eth1 and eth2 machines are perfectly happy with the MAC addresses they use. Of course there is one last problem in that, if there is never an ARP request from eth2 to eth0 for the IP address now talking to eth1, eth1's computer can never get an ARP request back to eth0 and thus the conversation will never take place. A specific implementation uses gratuitous ARPs. However, in other configurations, that is not necessary.

Options Description and Syntax: (<Options>)

According to specific embodiments of the present invention, IR operation can be modified by one or more of the following options.

-C If this rule fires, rule evaluation continues

-A Always respond (ignore mask) (default)

-W n Ignore each n'th packet

-X n Alternate responding to each n'th packet

-E n Randomly (e.g., using a PRNG) generate errors in the packet with P(error)=n/255 (default 0);

-R n Random Respond or ignore with P(ignore)=n/255

-P Set priority to min delay/max throughput

-L Log to syslog

-F<f>+ TCP flags (sYN, aCK, pSH, fIN, rST, uRG) (exact match)

-K Match non-fragmented packets (generally applies only to IP)

-O<os> Forge OS fingerprint of <os> MAC address rules

-G Randomly (e.g., using a pseudo random number generator) generate a MAC address for every ARP (default)

-F MAC Use MAC as the mac address (MACADDR 6 fields: separated from [0-9rf])

-T Fixed MAC address, which allows the address to be set to a previously stored value associated with the history of packets coming in and out

-d Destination MAC address (with T only)

-s Source MAC address (with T only)

-C: Continuation

An IR according to specific embodiments of the invention normally stops processing rules when it encounters a match. The continuation option (-C) causes the IR to continue processing rules after a first match and/or every match, allowing multiple matches. For example: eth0 {*.*.*.**.*.*.* -c F eth1; . . . } will copy all packets arriving on eth0 to eth1—and continue processing rules. This can be understood as causing a ‘beam splitter’ effect—two packet streams out of one. This technique has many applications, such as, for example, for feeding an intrusion detection system (IDS)—and with no return rule, the IDS can not send anything back out, so it cannot really be detected. The continuation option also provides handy methods for dealing with logging.

-A: Always Respond (Default)

The -A option is the default and it causes all responses to always operate. A usage example is eth0 {*.*.*.**.*.*.* -A F eth1;}.

The following options allow a user to select and/or construct a variety of packet responses that due to their strangeness tend to confuse or slow various protocols, in particular protocols or methods for attacking computer systems.

-W: Ignore Every Nth Packet

The W option makes packets disappear with regularity. For example:

eth0 {*.*.*.* -W 3 F eth1;} will cause every 3^{rd} packet to be ignored rather than forwarded. If mixed with mirroring, for example, an IR can cause telnets to replay old packets and thus slow the TCP protocol down:

eth0 {T *.*.*.**.*.*.* -W 3 M;}.

-X: Alternate Respond or Ignore Every Nth Packet

The X option makes packets alternate between being ignored and not being ignored. For example:

eth0 {T *.*.*.**.*.*.* -X 3 M;} will mirror for 3 packets then ignore for 3 packets then mirror for 3 packets then ignore for 3 packets and so on.

The -W and -X options in some implementations can be somewhat obvious indicators of an IR—and these commands are typically used for the purposes of slowing down an attacker's TCP sessions, general confusion, as a response to detected attackers, and to indicate to the most sophisticated attackers that they may have been detected and that the IR may be in use. This turns out to be a useful thing to do because keeping the IR and its function secret are not always the best way to use it. For example, it may be desirable to make it appear as though the IR is occupying part of the IP space to cause attackers to look elsewhere.

This can be used to cause attackers to spend too much time looking into a useless part of the IP search space. Assuming an attacker might read the description provided herein and watch what they do to decide how to use the IR best in any given situation, the following option is provided:

-R n: (Pseudo-)Randomly Ignore Packets with a Probability n/255 (Default 0)

This option uses a pseudo-random number generator to decide when to ignore packets as if they never existed. Unlike the earlier two obvious examples, this option is far harder to detect or analyze—it simply appears to be a noisy communications line or unreliable channel. It can be used, for example, to cause technicians to waste a lot of time trying to figure out what's wrong with their systems, to slow down TCP connections to a desired level, or for other similar applications. It is far harder to detect than the previous options and is thus designed for more realistic errors. As further examples, consider the two rules:

eth0 {T *.*.*.**.*.*.*. -R 64 F eth1;}

eth1 {T *.*.*.**.*.*.*. -R 192 F eth0;} In this example, ¼ of the time, on average, the packets from eth0 will be ignored, and the other half of the time they will be forwarded to eth1—while the reverse path will work ¾ of the time.

-E n Randomly (e.g. Using a PRNG) Generate Errors in the Packet with P(Error)=n/255 (Default 0);

Similarly to the above, this option uses a pseudo-random number generator to decide when to add errors to packets, such as bad checksums, etc. This option is also harder to detect or analyze—it simply appears to be a noisy communications line or unreliable channel. It can be used, for example, to cause technicians to waste a lot of time trying to figure out what's wrong with their systems, to slow down TCP connections to a desired level, or for other similar applications.

-P Set Priority to (Min-Max Delay/Min-Max Throughput)

This option sets the priority of outbound packets.

-L Log to Syslog

This option logs to syslog or other file or logging method or system for capture and analysis by remote devices. In particular implementations, it is important to use a control channel, as this log is not encrypted. Other embodiments provide for encryption for the log.

-F<f>+ TCP Flags (sYN, aCK, pSH, fIN, rST, uRG)

-F<f>+ ARP Flags (REQUESt, REPLy)

This option allows a TCP or ARP rule to be applied only when TCP flags are present in the TCP header or a particular type of ARP packet arrives. According to specific embodiments of the invention, it only triggers if ALL of the identified flags are present and no others. Use multiple rules for different flag sets if desired. For example to ignore SYN packets (and thus prevent initiations of TCP sessions from eth0), one could use: eth0 {T *.*.*.**.*.*.* -Fs I;}

-K Match Non-Fragmented Packets (Applies Only to IP)

This option is used to match only packets that are not IP fragmented and generally only applies to IP packets. Use two rules to match fragmented packets, first using the -K. The second rule should have the same IP and port ranges, no -K option, and a different action. For example, to forward all traffic, ignoring fragmented packets, one could for example use:

eth0 {*.*.*.**.*.*.* -K F eth1;

*.*.*.**.*.*.* I;}

-O <“OS name”> Forge OS Fingerprint

This option provides specific support to counter specific OS fingerprinting techniques. To counteract, for example, nmap, a defender can tell the IR to emulate a particular CISCO router or any other OS for which emulation support is provided according to specific embodiments of the invention.

eth0 {T *.*.*.**.*.*.* -O1 Z;}

According to specific embodiments of the invention, an OS deception mechanism can include specific rules to fool NMAP scans. Although the -O option can be used in other rules to emulate actual OS behaviors, the example rules provided below ensure a correct NMAP fingerprint response to the particular IP(s) (ex. 10.0.0.1) according to the OS fingerprint file provided by NMAP. For further information about NMAP OS fingerprint files, see http://www.insecure.org/nmap/nmap-fingerprinting-article.html.

eth0 {U *.*.*.* 10.0.0.1 -O “Windows 2000 Professional” D;

T *.*.*.* 10.0.0.1:1-20 -O “Windows 2000 Professional” Z;}

This syntax can be understood as follows:

U *.*.*.* 10.0.0.1 -O “Windows 2000 Professional” D; enables response to the UDP close port scan test initiated by NMAP. This test (combined with the TCP open and close port tests mention below) allows NMAP to differentiate different OS's.

T *.*.*.* 10.0.0.1:1-20 -O “Windows 2000 Professional” Z; enables responses to the TCP open and close port tests initiated by NMAP. In the above case ports 1-20 will provide the open port tests while all other ports (21+) will provide close port tests. These tests (combined with the UPD close port test mention above) allows NMAP to differentiate different OSs. In this case the Operation System “Windows 2000 Professional” is being spoofed.

In this particular example, both rules should have the same OS name or otherwise IR will not be able to send out correct NMAP responses to spoof NMAP scans. However this is up to the user of the IR, as different OS names can be use in different rules to fool NMAP scans as well. Of course this may or may not accomplish the deception level desired. Furthermore, the OS name given to the -O option should be an exact match from the NMAP fingerprint file, which can be downloaded from http://www.insecure.org/nmap/. An IR according to specific embodiments of the invention is designed to utilize OS fingerprints from such files and follows the formats specific to such files to spoof responses to NMAP scans.

In further embodiments, an IR can include additional OS fingerprint spoofing mechanisms in response to Xprobe2 scans (http://www.sys-security.com/html/projects/X.html). This is an additional capability to the above rules. This is accomplished by spoofing responses to ICMP scans initiated by Xprobe2. This capability can be activated by the above rules or any rule with -O option, provided there is no conflict in the rules. Rules like {I *.*.*.* 10.0.0.1 -O “Windows 2000 Professional” I} which ignores all ICMP packets, thus render the OS ICMP spoofing mechanism inoperative. The IR is designed to utilize OS fingerprints from the Xprobe2 fingerprints file which can be obtain from Xprobe2 in order to spoof ICMP responses to Xprobe2 scans.

Example MAC Address Rules and/or Options:

The previous options have all been for packets that get forwarded or mirrored or some similar action. There are also options for MAC addresses intended to provide appropriate (in)consistency for attackers who bother to notice such things (as any good attacker would do if they suspected deception).

-G: Generate Random MACs

This option uses a pseudo-random number generator (PRNG) to generate a MAC address for every ARP request it responds to. This is the default. It is a bit confusing because that means that the apparent network card of the IP address changes every time it is checked. Nevertheless the packets always get through. This is very strange behavior to any observer especially considering that MAC addresses indicate interface card types and manufacturers. An example:

eth0 {*.*.*.**.*.*.* -G F eth1;}. Note that the -G is unnecessary in specific embodiments because it is the default.

-F: Functional MAC Addresses

This option provides flexibility in setting the MAC address or fields therein. It separates MAC addresses into the 6 bytes they are composed of and allows control over each byte. There are three options for byte values in the IR:

g byte value is a pseudo-random function of IP address

r byte value is a pseudo-random function of an internal random seed

[0-9]+ byte value is as specified.

The following provides an example of how these functions can be combined:

eth0 {172.96.0.0:b 10.0.0.0:b -F 12:23:21:g:r:g F eth1;}

In this case, the instruction has specified the MAC address of every IP in the space of 10.0.* as being a sequence of fixed byte values for the first three bytes, followed by a byte that is a function of the IP address, a random byte, and a byte that is a function of the IP address. This example shows how an IR according to specific embodiments of the invention does it, but is not preferred for actual use. In actual use, the following would be preferable:

eth0 {10.1.*.* 10.2.0.*-m 0:160:204:g:g:g Z;

10.1.*.* 10.3.0.*-m g:g:g:g:g:g M;

10.1.*.* 10.4.0.*-m r:r:r:r:r:r Z;

10.1.*.* 10.5.0.*-m 0:160:204:12:23:65 M;}

The first line above specifies the manufacturer and card type and allows the MAC address to vary with the specific IP address. Each IP address will thus have a unique MAC address that is used every time that IP address is used. This will emulate a normal Ethernet card in a normal system. There are lists of valid manufacturers and card types available from the Internet. The EthernetCards has the listing of manufacturers and their assigned address spaces. In the second line, the whole MAC address is a function of the whole IP address. Thus each card will appear to have different (often non-existent) manufacturers and card types, but they will be consistent with the IP addresses. Note that the same byte values will appear for the same parts of the MAC address if the same random seeds are used and the same IP addresses are used to generate values. This can reveal the operation of the IR if care is not used.

The third line simply makes up a new MAC address every time it is asked. There is no correlation between a MAC address and an IP address and thus it is a bit confusing. The fourth line specifies a fixed MAC address for all IPs corresponding to the specified interface and IP range. This is indicative of some sort of a gateway or multi-addressed computer.

-S/-D: MAC Address Selection for Transposition

The transposition operation allows address translations to be made by the IR, but in the process, something has to be done to make MAC addresses come out right. The solution is the MAC source/destination replacement mechanism. As an example:

eth0 {10.0.0.* 10.0.5.*-d +eth1 T 10.0.0.+0 10.0.−4.+0 eth1;}

will transpose packets from 10.0.0.X to 10.0.5.Y on eth0 to 10.0.0.X to 10.0.1.Y on eth1, using the MAC for 10.0.1.Y in eth1 after the transpose. The ‘-d eth1’ indicates that the destination MAC is changed afterwards. This example adjusts the source MAC address before transposition.

eth1 {10.0.1.* 10.0.0.*-s −eth2 T 10.0.+4.+0 10.0.0.+0 eth0;}

will transpose packets from 10.0.1.Y to 10.0.0.X on eth1 to 10.0.5.Y to 10.0.0.X on eth0, using the MAC for 10.0.1.Y in eth2 before the transpose (otherwise, if after, the IR would look up 10.0.5.Y in the eth2 ARP table).

To clarify, -d is destination MAC address. -s is source MAC address, +ethx means to copy the MAC address stored from the ethx interface based on the IP address AFTER it is translated by the ‘T’ action, while −ethx means to put in the ARP address for the IP address before translation as last seen on ethx. If the IR does not find an IP in the MAC hash, it will drop the packet and will give the message: . . . <some things> . . . DROPPED-TRANSPOSE . . . <some things> . . . .

### Embodiment in a Programmed Digital Apparatus

The invention may be embodied in a fixed media or transmissible program component containing logic instructions and/or data that when loaded into an appropriately configured computing device will cause that device to perform in accordance with the invention.

FIG. 14 illustrates an example logic or information handling device in which aspects of the present invention may be embodied. FIG. 14 shows digital device 700 that may be understood as a logical apparatus that can read instructions from media 717 and/or network port 719. Apparatus 700 can thereafter use those instructions to direct one or more methods for network communication data handling as described herein. One type of logical apparatus that may embody the invention is a computer system as illustrated in 700, containing CPU 707, optional input devices 709 and 711, disk drives 715 and optional monitor 705. Fixed media 717 may be used to program such a system and could represent a disk-type optical or magnetic media or a memory. Communication port 719 may also be used to program such a system and could represent any type of communication connection. Communication port 719 may also be used to send and/or receive data units as described herein and to communication with a communication media network.

The invention also may be embodied within the circuitry of an application specific integrated circuit (ASIC) or a programmable logic device (PLD). In such a case, the invention may be embodied in a computer understandable descriptor language which may be used to create an ASIC or PLD that operates as herein described.

The invention also may be embodied within the circuitry or logic processes of other digital apparatus, such as firewalls, routers, PCs on a network, etc.

### CONCLUSION

The invention has now been explained with regard to specific embodiments. Variations on these embodiments and other embodiments will be apparent to those of skill in the art. The invention therefore should not be limited except as provided in the attached claims. It is understood that the examples and embodiments described herein are for illustrative purposes only and that various modifications or changes, in light thereof will be suggested to persons skilled in the art and are to be included within the spirit and purview of this application and scope of the appended claims. All publications, patents, and patent applications cited herein are hereby incorporated by reference in their entirety for all purposes.

What is claimed:

1. A method of specifying configurable behaviors in a communication system comprising:
specifying one or more rule sets using a rules syntax having a general form:
interface_indication {<rule1>;<rule2>;<ruleN>;}
wherein a <ruleN> is of a general form:
[<Protocol>]<Source><Destination>[<Option>]<Response>[<argument>]
wherein square brackets ([ ]) indicate elements that are optional in at least some instances;
wherein the characters “{” “}” and “;” indicate any defined or implied delimiters; and
wherein the characters “<” “>” indicate any defined or implied delimiters and/or indicate a name place holder.

2. The method according to claim 1 wherein <Protocol> indicates one or more protocols to which a rule applies.

3. The method according to claim 1 wherein <Source> and <Destination> each indicate an address or range of addresses to which a rule applies.

4. The method according to claim 1 wherein <Source> and <Destination> each indicate an address or range of address to which a rule applies; and
further wherein <Source> and <Destination> can be specified using a general form:
<IPRangeSet>[:<Class>] [:<PortRange>];
wherein square brackets ([ ]) indicate elements that are optional in at least some instances;
wherein the character “:” indicates any defined or implied delimiters.

5. The method according to claim 4 further wherein <Class> and <PortRange> are distinguished by having separate valid values defined for each, such as an alphabetic expression for <Class> and a numeric expression for <PortRange>.

6. The method according to claim 4 wherein <IPRangeSet> may be specified using an expression have general forms:
[˜]<IP> indicating a particular address or with a preceding negation character indicating all addresses except that address; and
[˜]<IP₁>+<IP₂> indicating a range of IP addresses from IP₁ to IP₂ or with a preceding negation character indicating all addresses except for that range;
wherein square brackets ([ ]) indicate elements that are optional in at least some instances;
wherein the character “+” indicate any defined or implied range operators;
wherein the character “˜” indicates any defined or implied negation character or other logical operator character; and
wherein the characters “<” “>” indicate any defined or implied delimiters and/or indicate a name place holder.

7. The method according to claim 6 wherein one or more IP addresses <IPᵢ> may be specified as:
a set of numerical values (e.g., a.b.c.d) where a.b.c.d each indicate a numerical value;
a set of ranges of said values (e.g., a_{Range}.b_{Range}.c_{Range}.d_{Range}); and
where a negation indication (e.g., ! or # or ˜) can be used to indicate negation of any part of said sets, (e.g., a.!b_{Range}.c.d_{Range}).

8. The method according to claim 7 wherein each range (e.g., a_{Range}) can be indicated by an numerical value expression such as value₁-value₂.

9. The method according to claim 1 wherein <Class> indicates an address class (or mask) for an address expression, indicating portions of the address expression to be evaluated and portions to be ignored.

10. The method according to claim 1 wherein <PortRange> indicates a port range to which a rule applies or, using a negation character, to which a rule does not apply.

11. The method according to claim 1 wherein <Response> indicates one or more actions to be taken by said invisible data handling module when a stimulus portion of a rule is matched.

12. The method according to claim 11 wherein said actions and their indications comprise any four are more selectable actions taken from the group consisting of:
I Ignore the packet
D Deny the packet
F<dev> Forward the packet
M Mirror the packet
R<IP>[port]<dev>[<dev>] Redirect the packet
V<IP>[port]<dev>[<dev>] Reverse redirection
B<IP><range> Broadcast response
Z<prob> Dazzle the sender
Y<dev1><dev2> Concealment mode (external)
H Concealment mode (hidden)
E Concealment mode (exposed)
L Loopback interface forwarding
T<sIPm><sPm><sMm><dIPm><dPm><dMm><dev> spoof IPs, ports, MACs, and wherein characters indicating the actions are codes that can be varied in specific embodiments.

13. The method according to claim 1 further comprising:
providing a set of indications allowing one or more options to be specified for a rule.

14. The method according to claim 13 wherein said options comprise any two or more selectable options taken from the group consisting of:
-C If this rule fires, rule evaluation continues
-A Always respond (ignore mask) (default);
-W n Ignore each n'th packet
-X n Alternate responding each n'th packet
-E n Randomly (e.g., using a PRNG) generate errors in the packet with P(error)=n/255 (default 0);
-R n Random Respond or ignore with P(ignore)=n/255
-P Set priority to min delay/max throughput
-L Log to syslog
-F<f>+ TCP flags (sYN, aCK, pSH, fIN, rST, uRG) (exact match)
-K Match non-fragmented packets (Applies only to IP)
-O<os> Forge OS fingerprint of <os> MAC address rules:
-G Randomly (e.g., using a pseudo random number generator, PRNG) generate a MAC address for every ARP (default);
-F MAC Use MAC as the mac address (MACADDR 6 fields: separated from [0-9rf])
-T Fixed MAC address
-d Destination MAC address (with T only)
-s Source MAC address (with T only); and
wherein characters indicating actions are codes that can be varied in specific embodiments.

15. A method of specifying one or more network (e.g., IP) addresses for address matching comprising:
using an expression of a general form [˜]<IP> to indicate a particular address or with a preceding negation character indicating all addresses except that address; and
using an expression of a general form [˜]<IP₁>+<IP₂> to indicate a range of IP addresses from IP₁ to IP₂ or with a preceding negation character indicating all addresses except for that range;
wherein square brackets ([ ]) indicate elements that are optional in at least some instances;
wherein “+” indicates any defined or implied range and/or logical operators;
wherein “˜” indicates any defined or implied negation character or other logical operator character; and
wherein “<” “>” indicate any defined or implied delimiters and/or indicate a name place holder.

16. The method according to claim 15 further wherein one or more IP addresses <IPᵢ> may be specified as:
a set of numerical values (e.g., a.b.c.d) where a.b.c.d each indicate a numerical value;
a set of ranges of said values (e.g., a_{Range}.b_{Range}.c_{Range}.d_{Range}); and
where a negation indication (e.g., ! or # or ˜) can be used to indicate negation of any part of said sets, (e.g., a.!b_{Range}.c.d_{Range}).

17. The method according to claim 16 further wherein each range (e.g., a_{Range}) can be indicated by a numerical value range expression such as value₁-value₂.
wherein “-” indicates any defined or implied range and/or logical operators;

18. The method according to claim 17 further wherein each range logical operators and negation operators and address logical operators and negation operators are indicated by differing characters.

19. The method according to claim 15 further comprising optionally specifying class and port using an expression of a general form:
<IPRangeSet>[:<Class>] [:<PortRange>]

20. The method according to claim 19 further wherein <Class> and <PortRange> are distinguished by having separate valid values defined for each, such as an alphabetic expression for <Class> and a numeric expression for <PortRange>.

21. The method according to claim 19 wherein <Class> indicates an address class (or mask) for an address expression, indicating portions of the address expression to be evaluated and portions to be ignored.

22. The method according to claim 19 wherein <PortRange> indicates a port range to which a rule applies or, using a negation character, to which a rule does not apply.

23. A logic system for handling network communication packets comprising:
at least one interface for sending and receiving network communication packets;
a processor able to execute logic instructions and examine said packets; and
a logic module able to compare said packets address ranges expressed using the method of claim 1.

24. The system of claim 23 further comprising:
a syntax parser logic module for reading packet address range expressions and generating logic instructions executable on said processor.

25. A system for processing data communication packets comprising:
means for reading an expression of the form [˜]<IP> to indicate a particular address or with a preceding negation character indicating all addresses except that address;
means for reading an expression of the form [˜]<IP₁>+<IP₂> to indicate a range of IP addresses from IP₁ to IP₂ or with a preceding negation character indicating all addresses except for that range;
wherein square brackets ([ ]) indicate elements that are optional in at least some instances;
wherein “+” indicates any defined or implied range and/or logical operators;
wherein “˜” indicates any defined or implied negation character or other logical operator character;
wherein “<” and “>” indicate any defined or implied delimiters and/or indicate a name place holder;
means for reading IP addresses <IPᵢ> be specified as a set of ranges of numerical values said values with optional a negation indications used to indicate negation of any part of said sets; and
means for reading configurable responses and/or actions to indicated addresses;
means for performing indicated responses and/or actions.

26. A stored program product on a media that when transferred to and executed in an appropriately configured computer device enables the device to perform the method of claim 1.

27. A stored program product on a media that when transferred to and executed in an appropriately configured computer device enables the device to embody the system of claim 23.
